(19) United States
(12) Patent Application Publication
(10) Pub. No.: US 2023/0330516 A1
(43) Pub. Date: Oct. 19, 2023

(54) PLAY FIELD FOR CASINO DICE TABLES

(71) Applicant: ARUZE GAMING AMERICA, INC., Las Vegas, NV (US)

(72) Inventor: Keiichi KOJIMA, Tokyo (JP)

(21) Appl. No.: 18/193,376

(22) Filed: Mar. 30, 2023

Related U.S. Application Data
(60) Provisional application No. 63/331,151, filed on Apr. 14, 2022.
(60) Provisional application No. 63/394,835, filed on Aug. 3, 2022.

(51) Int. Cl. A63F 3/00

(52) U.S. Cl. CPC A63F 3/00157; A63F 3/00643; A63F 2003/00164

(57) ABSTRACT

A play field for a casino dice table may comprise a play field and an electronic display device. The play field may comprise a middle portion disposed between first and second end portions. Each portion may comprise a flexible, light transmissive material, a thickness and a hardness. The thickness of the first and second end portions may each be greater than the thickness of the middle portion. Each first and second end portion may comprise multiple different thicknesses. The hardness of the middle portion may be the same as one or both of the first and second end portions. The hardness of the middle portion may be greater than a hardness of the first and second end portions. The electronic display device may be positioned under the play field and configured so that images displayed by the electronic display device are viewable on, or through, the play field.

### CROSS-REFERENCE TO RELATED APPLICATIONS

This application claims the benefit of U.S. Provisional Application No. 63/331,151 filed Apr. 14, 2022, and U.S. Provisional Application No. 63/394,835 filed Aug. 3, 2022. The above-referenced patent applications are incorporated by reference in their entirety.

### BACKGROUND OF THE INVENTION

### Field of the Invention

The present disclosure relates to improvements to play fields for casino dice tables, and specifically play fields of physical dice tables having electronic displays displayed on, or through, the play field.

### Description of the Related Technology

Casino dice tables have been common in casinos for decades. These dice tables are utilized for casino games such as Craps and Sic Bo, variations thereof, as well as other casino games where physical dice are utilized to determine a result of a wager. In that sense, the physical dice act as a random number generator, or RNG, for the game, and are utilized much like a computerized RNG is used by a modern slot machine to determine results.

Recently, many casino equipment providers have started to offer casino dice tables with a modified play field configured to allow an electronic display to be displayed through the play field so that the displayed images are viewable by a player. However, the traditional play field covering material, typically felt or a similar textile, has not allowed adequate clarity of a displayed image, especially a dynamic video display. Felt has been a good traditional play field material because of its associated properties to provide some absorption of the energy from dice when they are thrown, because its durability and long service life, and its ability to provide enough friction to help prevent dice from sliding.

Urethane layers have been used as the top layer of a play field, which has shown to have good dice-energy absorption and durability properties. Equilateral triangle-shaped bumpers placed across a portion of the play field have also been used to help promote dice tumbling and to prevent dice from sliding. However, such bumpers cannot be placed across the entire width of the play field, as they do not allow the dealer to slide the dice back to the dealer position without the dice having to be pulled back over such a bumper, which causes the dice to potentially shift and change the result the dice displayed, thereby causing ambiguity as to the actual result of the dice throw.

What is needed is a casino dice table with a dice play field arrangement that allows an associated electronic display device to display through the play field, prevents dice from sliding or otherwise not tumbling adequately, and allows a dealer to retrieve thrown dice while reducing the likelihood that such thrown dice will change their displayed results.

### SUMMARY

The present disclosure provides an improved play field for a dice-based casino table. In one aspect, the table comprises a paly field and electronic display device. The play field may comprise a middle portion disposed between first and second end portions. Each portion may comprise a flexible, light transmissive material, a thickness and a hardness. The thickness of the first end portion may be greater than the thickness of the middle portion. The thickness of the second end portion may be greater than the thickness of the middle portion. In embodiments, the hardness of the middle portion may be greater than a hardness of the first end portion, and a hardness of the second end portion. In other embodiments, the hardness of the middle portion may be the same or substantially the same as the hardness of the first end portion and the hardness of the second end portion. The electronic display device may be positioned under the play field and configured so that images displayed by the at the electronic display device are viewable on, or through, the play field.

### BRIEF DESCRIPTION OF THE DRAWINGS

FIG. 1 is a general view of a casino dice table with an electronic display, according to embodiments of the present disclosure.

FIG. 2A is a side view of a play field and a flat-panel display, according to embodiments of the present disclosure.

FIG. 2B is a side view of play field and a projection display, according to embodiments of the present disclosure.

FIGS. 3A & 3B are side views of a play field comprising end portions and a middle portion in which each end portion has a greater thickness than the middle portion and a different hardness from the middle portion, according to embodiments of the present disclosure.

FIGS. 4A & 4B are side views of a play field comprising end portions and a middle portion in which each end portion has a greater thickness than the middle portion and a different hardness from the middle portion, according to additional embodiments of the present disclosure.

FIGS. 5A & 5B are side views of a play field comprising end portions and a middle portion in which each end portion has a greater thickness than the middle portion and a different hardness from the middle portion, according to still further additional embodiments of the present disclosure.

FIGS. 6A & 6B are side views of a play field comprising end portions and a middle portion in which each end portion has a greater thickness than the middle portion and each end portion comprises three steps or stepped portions.

FIG. 7 is a side view of a play field comprising bumpers, according to further embodiments of the present disclosure.

Throughout the drawings, identical reference numbers designate similar, but not necessarily identical, elements. The figures are not necessarily to scale, and the size of some parts may be exaggerated to more clearly illustrate the example shown. Moreover, the drawings provide examples consistent with the description; however, the description is not limited to the examples provided in the drawings.

### DETAILED DESCRIPTION

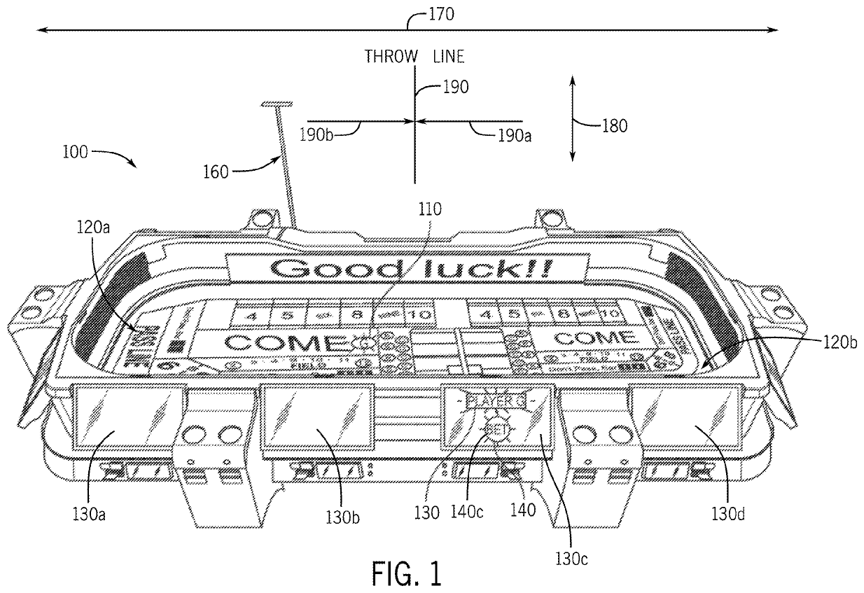

FIG. 1 illustrates a casino dice table 100 according to embodiments of the present disclosure. In certain embodiments, the game for the casino dice table may be craps, as generally shown in FIG. 1. Casino dice table 100 comprises a play field 110, which provides information for the associated dice game and a top surface upon which associated dice may roll. In embodiments, casino dice table 100 includes a plurality of player stations 130a, 130b, 130c, 130d (collectively referred to as player stations 130), which allow a player of the casino dice table 100 to make various inputs through a player input device, shown as 140c with respect to player station 130a in FIG. 1, but understood in various embodiments as being associated with each of the player stations 130a, 130b, 130c, 130d. Examples of such casino dice tables including example software and architecture for such tables are illustrated and described in U.S. Pat. No. 10,540,853, the entire contents of which are incorporated herein.

To aid in understanding the positioning of various elements and features of the casino dice tables and play fields of the present disclosure, reference is made herein to (i) a lateral direction 180, which may be considered a horizontal or substantially horizontal direction, i.e., into and out of the paper in the illustrated figures, and (ii) a longitudinal direction 170, which may also be considered a horizontal or substantially horizontal direction from left to right or right to left in the illustrated figures, and (iii) a throw line 190. It should be appreciated that these directional and/or positional references may be applicable to each of the embodiments and figures illustrates and described herein. For the embodiments illustrated by the example casino dice table 100 of FIG. 1, it is contemplated that, for a play of the game, a player would be required to throw dice in one of the longitudinal directions indicated by arrows 190a, 190b associated with the player's location relative to a respective longitudinal side of throw line 190. It is further contemplated that such thrown dice would be required to reach at least one end or dice receiving area 120a or 120b. In various embodiments, the dice may bounce off of a wall of the casino dice table 100 as is common in the game of craps. Then, a dealer would typically use a dice stick 160 to retrieve the dice from the end 120a or 120b where the dice stopped, while taking care to not allow the dice to shift or change the results that were displayed when the dice stopped.

In a further example, a player located at a position of one of the player stations 130 would be required to throw dice from the player's position towards an opposite end 120a from the player's position. For example, a player located at player station 130b would be required to throw dice from the location of player station 130b towards the end 120b. As illustrated, the throw line 190 is generally located near the center of casino dice table 100 and generally splits the player stations 130 into table halves, thereby requiring each player to throw dice from their respective player position to an opposite end 120a or 120b that is furthest away from the player's position. Requiring such action helps make sure the thrown dice provide random results, thereby maintaining the fairness of the associated dice game.

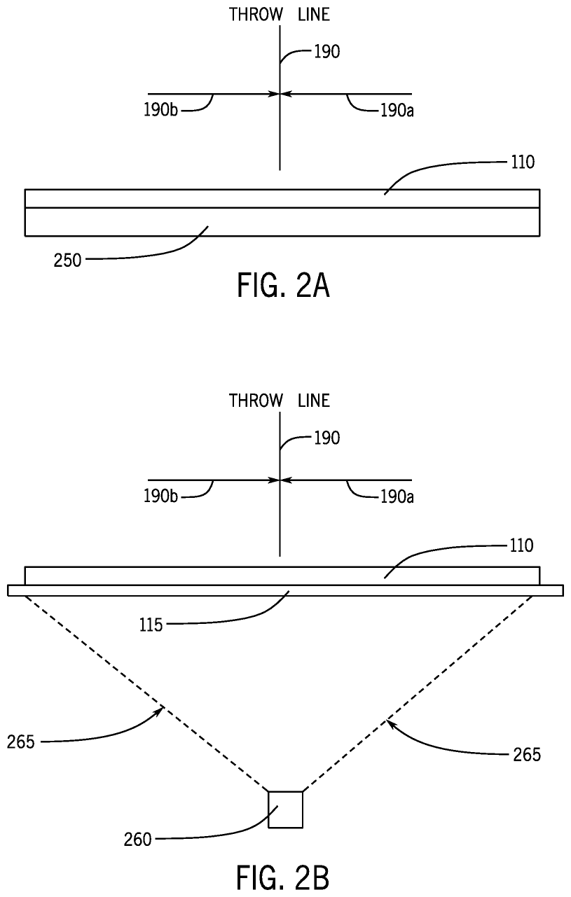

FIG. 2A and FIG. 2B illustrate side views of embodiments of a play field 110 and associated electronic display devices. In these embodiments, play field 110 may comprise at least one sheet of urethane. In other embodiments, play field 110 may comprise a different elastomer material. In further embodiments, play field 110 may comprise a plastic material. It is contemplated that play field 110 may comprise any suitable flexible and moderate to high light-transmissive material. A play field 110 that is flexible provides a beneficial surface for physical dice to be thrown or rolled upon, as the flexible surface provides some absorption of energy properties when the dice contact the play field 110. Such properties help prevent dice from bouncing off of the casino dice table 100 and help promote rolling of the dice. The moderate to high light-transmissivity of play field 110 allows the underlying electronic display device to adequately show through the play field 110 and provide information to player(s). In various embodiments, a moderate light-transmissive material may be desired if the underlying electronic display device displays mostly static images, while in other embodiments a high light-transmissive material may be desired if the underlying electronic display device displays more dynamic (e.g., video) images. In further embodiments, urethane or similar water-resistant materials, may provide the added benefits of protecting the underlying electronic display device from casino environments that may shorten the life or usability of a casino dice table, e.g., spilled drinks, cigarettes, glassware, and the like. For example, it is much easier to clean a spilled drink from a urethane surface than to clean a spilled drink from a felt material. And spilled drinks are much less likely to seep through to the underlying electronic display device.

FIG. 2A illustrates a side view of embodiments of a play field 110 and an underlying electronic display device that comprises a flat-panel display device 250. While FIG. 2A illustrates only a single flat-panel display device 250, in embodiments, casino dice table 100 may utilize a plurality of flat-panel display devices 250 to provide the desired coverage of play field 110. In further embodiments, additional materials, such as a rigid protective layer 115 (illustrated as an example in FIG. 2B) may be positioned between the flat-panel display device 250 and the play field 110. The additional materials such as a rigid protective layer, may provide additional protective or heat dissipation properties. In embodiments, the flat-panel display device 250 may be any adequately bright flat-panel display device, such as a liquid crystal display (LCD), a light emitting diode (LED) display, a Light Emitting Diode (LED) backlit Liquid Crystal Display (LCD) display, an organic light emitting diode (OLED) display, quantum dot light emitting diode (QLED), plasma display, or an LCD pixel matrix.

FIG. 2B illustrates a side view of embodiments of a play field 110 and an underlying electronic display device comprising a projection display device 260. Projection display device 260 may comprise an associated image projection area, illustrated generally with dashed lines 265. While FIG. 2B illustrates only a single projection display device 260, in embodiments, casino dice table 100 may utilize a plurality of projection display devices 260 to provide the desired coverage of the play field 110. In embodiments, a rigid protective layer 115 may be positioned underneath play field 110. The flexible play field 110 may be supported by the rigid protective layer 115 in certain embodiments to help maintain the shape and layout of play field 110. In various embodiments, the rigid protective layer 115 comprises at least one glass sheet. In other embodiments, the rigid protective layer 115 may comprise plexiglass. Rigid protective layer 115 in embodiments may be comprised of a rigid, highly light-transmissive material, such as glass or plexiglass, and be sufficiently rigid to provide protection to any underlying electronic display device. Projection display device 260 in various embodiments may be any commercially suitable digital projector, including but not limited to, a liquid crystal display (LCD) projector, a digital light processing (DLP) projector with single chip or three-chip, a liquid crystal on silicon (LCoS) projector, a multi-LCD laser light source projector, or any other digital projector offering good resolution.

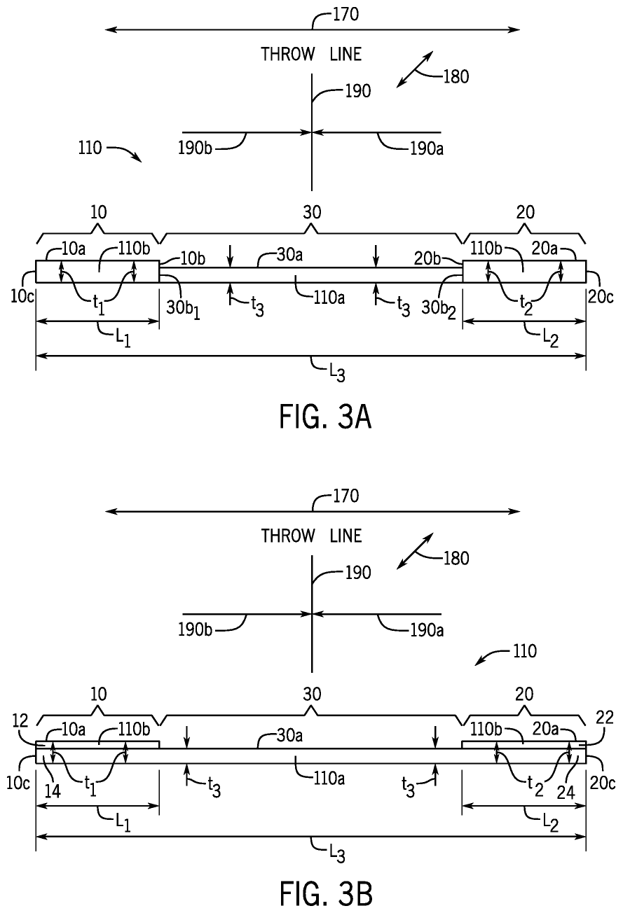

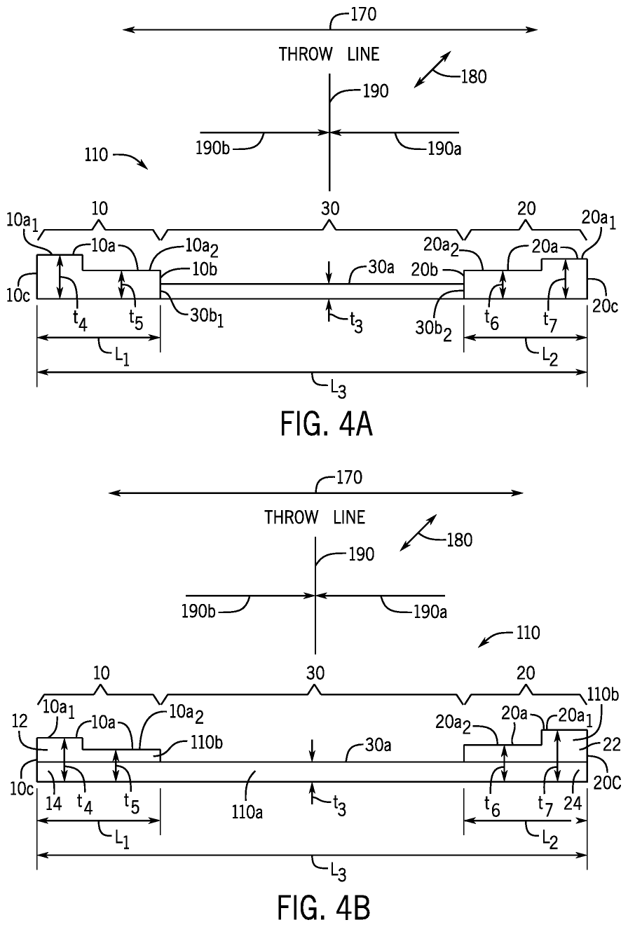

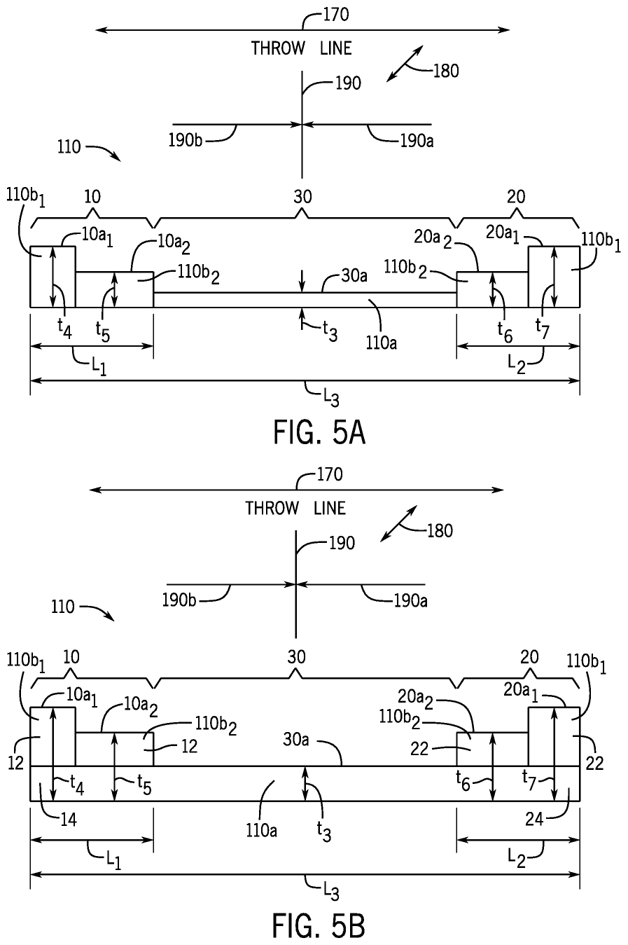

FIGS. 3A-5B each illustrate side views of embodiments of a play field 110 comprising a first end portion 10, a second end portion 20 and a middle portion 30 in which (i) the first and second end portions 10, 20 each comprise a height or thickness, e.g., t1, t2 (See, FIGS. 3A, 3B) or t4, t5 and t6, t7 (See, FIGS. 4A, 4B, 5A, 5B), greater than the height or thickness t3 of the middle portion 30, and (ii) at least a portion of the middle portion 30, including the top surface 30a of middle portion, comprises a hardness that is greater than a hardness of at least a portion of the first and second end portions 10, 20, including their respective top surfaces 10a, 20a. As illustrated, the first end portion 10 is located at one longitudinal end or end portion of play field 110, and the second end portion 20 is located at an opposite longitudinal end or end portion of play field 110. The middle portion 30 is disposed or positioned between the first end portion 10 and the second end portion 20. The first end portion 10, second end portion 20 and middle portion 30 comprise respective top surfaces 10a, 20a, 30a. Each top surface 10a, 20a, 30a may be configured to allow dice to roll thereupon, to stop (or land) and be substantially flat. It should be appreciated that each of the substantially flat top surfaces 10a, 20a, 30a may extend laterally from one lateral edge of play field 110 to an opposite lateral edge of play field 110, or extend laterally from one lateral wall of the casino dice table to an opposite lateral wall of the casino dice table.

As shown, the first end portion 10 may comprise a thickness that is greater than a thickness t3 of the middle portion 30. The second end portion 20 similarly may comprise a thickness that is greater than a thickness t3 of the middle portion 30. In some embodiments, the thickness of the first end portion 10 and the thickness of the second end portion 20 each may be 5 mm, 6 mm or 7.5 mm, while the thickness t3 of the middle portion 30 may be 3 mm. In other embodiments, the thickness difference between the first end portion 10 and the middle portion 30 may be slightly different from the thickness difference between the second end portion 20 and the middle portion 30 so long as (i) the thickness of the first end portion 10 is greater than the thickness t3 of the middle portion 30, and (ii) the thickness of the second end portion 20 is greater than the thickness t3 of the middle portion 30. It should be appreciated that these thickness differences may create or define a step or stepped portion positioned at, near or within respective longitudinal end or end portions of the play field 110.

It should also be appreciated that the thickness of each of the first end portion 10 and the second end portion 20 in embodiments may comprise more than one thickness that is greater than the thickness of the middle portion 30. For example, referring to the embodiments illustrated by FIGS. 4A-5B (as discussed further below), the thickness of the first end portion 10 may comprise a first thickness t4 and a second, different thickness t5 that is positioned adjacent to the first thickness t4 and closer to the center of the play field 110 or throw line 190. The first thickness t4 may be greater than the second thickness t5, thus creating two steps or stepped portions, i.e., one step or stepped portion defined by the difference in height or thickness between t3 of middle portion 30 and t5 of first end portion 20 and another step or stepped portion defined by the difference in height or thickness between t5 of first end portion 20 and t4 of first end portion 10. Similarly, the thickness of second end portion 20 may comprise a first thickness t7 and a second different thickness t6 positioned closer to the center of play field 110 or throw line 190. The first thickness t7 may be greater than the second thickness t6, thus creating two steps or stepped portions, i.e., one step or stepped portion defined by the difference in height or thickness between t3 of middle portion 30 and t6 of the second end portion 20 and another step or stepped portion defined by the difference in height or thickness between t6 of second end portion 20 and t7 of second end portion 20. In one example, the thickness of middle portion 30 may be 3 mm, while the first thickness t4 of first end portion 10 may be 7.5 mm and the second thickness t5 of first end portion 10 may be 6 mm, although other suitable thickness differences between t4 and t5 are contemplated. Similarly, in one example, the thickness of middle portion 30 may be 3 mm, while first thickness t7 of second end portion 20 may be 7.5 mm and the second thickness t6 of second end portion 20 may be 6 mm, although other suitable thickness differences between t7 and t6 are contemplated.

The thickness differences between (i) the first end portion 10 and the middle portion 30, (ii) the second end portion 20 and the middle portion 30, as well as (iii) the first and second thicknesses of each of the first 10 and second 20 end portions are not expected to cause a noticeable disruption to the images displayed on or through play field 110. The thickness differences will, however, aid in preventing dice from sliding on the play field 110. This is because the thickness differences create or define one or more step or stepped portion, each of which has an edge or edge surface sufficiently high to cause the dice to further tumble as the dice moves across the edge or edge surface. In some examples, a thickness difference of (i) 1.5 mm (e.g., the difference between the two thicknesses at each end portion), (ii) 2 mm (i.e., 5 mm versus 3 mm), or (iii) 3 mm (i.e., 6 mm vs 3 mm) provides these advantageous, in other embodiments, the thickness difference may be up to 7 mm and provide such advantages over traditional play fields. It should be appreciated that the play field thickness differences described herein should not be so great as to prevent thrown dice from continuing their roll direction (e.g., away from the throw line 190 to an end or end portion of the play field 110) and/or cause a noticeable obstruction to images being displayed, but the thickness differences should be great enough to cause the sliding dice to further tumble. Another advantage to the embodiments illustrated and described with respect to FIGS. 3A-5B is that the thickness differences create (i) upward step(s) or upward stepped portion(s) in the direction that dice will be thrown for a play of the game (e.g., in a direction away from the throw line 190 towards an end or end portion of the play filed 110) to help prevent the dice from sliding, and (ii) downward step(s) or downward stepped portion(s) in a direction of retrieval of the dice by the dealer, which reduces the likelihood of the dice further tumbling or changing their displayed result while the dealer is pulling the dice.

The first end portion 10, the second end portion 20 and the middle portion 30 each may have a width defined in the lateral direction 180. The first end portion 10 and the second end portion 20 may have respective lengths L1, L2 defined in the longitudinal direction 170. The play field 110 may similarly have a length L3 defined in the longitudinal direction 170. In various embodiments, the widths of each of the first and second end portions 10, 20 may extend in the lateral direction 180 all the way across a casino dice table, e.g., from one lateral side wall of a casino dice table to another other lateral side wall of a casino dice table, or from one lateral edge of a play field to an opposite lateral edge of the play field. The width of the middle portion 30 may likewise extend in the lateral direction 180 all the way across a casino dice table, e.g., from one lateral side wall of a casino dice table to another other lateral side wall of a casino dice table, or from one lateral edge of a play field to an opposite lateral edge of a play field. It should thus be appreciated that each of the thicknesses t1-t7 may extend and be substantially uniform across the entire width of the casino dice table or play field, e.g., from one lateral side wall of a casino dice table to another other lateral side wall of a casino dice table, or from one lateral edge of the play field to an opposite lateral edge of the play field. It should also be appreciated that the thicknesses t1-t7 of the first portion, second portion and third portions may be substantially uniform or the same across the entire lengths of the portions.

In embodiments, suitable lengths L1, L2 of the first and second portions 10, 20, respectively, may depend upon the length of the casino dice table or the length L3 of the play field 110 of the casino dice table. In some embodiments, the lengths L1, L2 may need to be a minimum of at least 12 feet. In other embodiments, the lengths L1, L2 may be between 20% and 35% of the length L3 of the play field 110. In embodiments in which a craps table is twelve feet long, the lengths L1, L2 may be between about 2.4 feet and 4.2 feet, which can be modified to conform to any standard play field material dimensions to help with production costs. It should be appreciated that if the lengths L1, L2 of first and second end portions 10, 20 are too long, then a player throwing dice from a position close to the throw line 190 may be able to reach the first or second end portions 10, 20 and slide the dice without the dice ever touching the middle portion 30. This would diminish the benefit of having first and second end portions 10, 20 with different thicknesses than the middle portion 30. Conversely, it should be appreciated that if the first or second end portions 10, 20 are too short, sliding dice thrown by a player may never reach the first or second end portions 10, 20 in a play of the dice game, and yet the player's throw may still be considered a valid roll from the perspective of sufficiently reaching one of the ends or dice receiving areas 120 of the play field 110.

Referring now more specifically to FIG. 3A, in these embodiments, the middle portion 30 comprises first and second longitudinal edges or faces 30b1, 30b2 and extends longitudinally from the first longitudinal edge or face 30b1 to the second longitudinal edge or face 30b2. The first end portion 10 similarly comprises first and second longitudinal edges or faces 10b, 10c and extends longitudinally from the first edge or face 10b to the second edge or face 10c. The first longitudinal edge or face 30b1 of middle portion 30 abuts or faces the first edge or face 10b of first end portion 10. The second end portion 20 also comprises first and second longitudinal edges or faces 20c, 20b and extends longitudinally from the first edge or face 20c to the second edge or face 20b. The second edge or face 30b2 of the middle portion 30 abuts, faces or is positioned adjacent to the second edge or face 20b of the second end portion 20. It should thus be appreciated that the middle portion 30 in these embodiments may comprise or define a unitary or integral piece (e.g., a single piece) of flexible light transmissive material 110a (which may be any suitable flexible, light transmissive material described herein). Similarly, the first end portion 10 may comprise or define a unitary or integral piece (e.g., a single piece) of flexible, light transmissive material 110b (which may be any suitable flexible, light transmissive material described herein). Likewise, the second end portion 20 may comprise or define a unitary or integral piece (e.g., a single piece) of flexible light transmissive material 110b (which may be any suitable flexible, light transmissive material described herein). It should also be appreciated that in some embodiments, the flexible light transmissive material 110b of the first end portion 10 may be the same as the flexible light transmissive material 110b of the second end portion 20, while in other embodiments the flexible light transmissive material 110b of the first portion 10 may be different from the flexible light transmissive material 110b of the second end portion 20.

Referring now more specifically to FIG. 3B, in these embodiments, rather than the first and second end portions 10, 20 having longitudinal edges or faces 10b, 20b that abut, face or are adjacent to respective longitudinal edges or faces 30b1, 30b2 of the middle portion 30, here a portion of the first end portion 10, a portion of the second end portion 20 and the middle portion 30 together may comprise or define a unitary or integral piece (e.g., a single piece) of flexible, light transmissive material 110a (which may be any suitable flexible light transmissive material as described herein) and define a bottom layer or bottom integral piece of play field 110. The integral bottom layer piece may extend underneath only a portion of the first and second end portions 10, 20, or may extend completely underneath the first and second end portions 10, 20 (e.g., from one longitudinal end of play field 110 to the other longitudinal end of the play field 110). In these embodiments, the first end portion 10 comprises a top portion 12 and a bottom portion 14 positioned under the top portion 12 (e.g., positioned directly under or abutting the top portion 12). The second end portion 20 likewise comprises a top portion 22 and a bottom portion 24 positioned under the top portion 22 (e.g., positioned directly under or abutting the top portion 22). The top portions 12, 22 each comprise respective top surfaces 10a, 20a. Each top surface 10a, 20a may be substantially flat and configured for dice to roll thereupon and to stop (or land). Middle portion 30 similarly includes a top surface 30a, which may also be substantially flat and configured for dice to roll thereupon and to stop (or land). In these embodiments, similar to the embodiments illustrated in FIG. 3A, the first and second end portions 10, 20 have respective heights or thicknesses t1, t2, each of which is greater than the height or thickness t3 of the middle portion 30. Here, the top portions 12, 22 of the first and second end portions 10, 20 may comprise a flexible, light transmissive material 110b (which may be any suitable flexible, light transmissive material described herein), while the bottom portion 14 (of first end portion 10), the bottom portion 24 (of second end portion 20) and the middle portion comprise a unitary or integral bottom layer piece of flexible, light transmissive material 110a (e.g., a single piece of material, which may be any suitable flexible, light transmissive material described herein). It should be appreciated that in some embodiments, the flexible, light transmissive material 110b of top portion 12 of first end portion 10 may be the same as the flexible, light transmissive material 110b of top portion 22 of second end portion 20, while in other embodiments the flexible, light transmissive material 110b of top portion 12 of first end portion 10 may be different from the flexible light transmissive material 110b of top portion 22 of second end portion 20.

It should be appreciated that the effect of the design of FIG. 3B is effectively the same as the design of FIG. 3A in that the first and second end portions 10, 20 create or define steps or stepped portions in the play field 110, which provides the same advantages described above. While the play field 110 illustrated in FIG. 3B may require a larger quantity of material to create the unitary or integral bottom layer piece, which may increase production costs, it may also decrease installation costs because arranging material pieces on top of one another (e.g., arranging the top portions 12, 22 on top of the bottom layer material piece) may be simpler than arranging material pieces so that they abut another as described in the embodiments of FIG. 3A. The embodiments of FIG. 3B also may provide efficiencies in retrofitting existing, traditional play fields, as the top portions 12, 22 could simply be applied to an existing play field.

Turning now more specifically FIG. 4A, these embodiments are similar to FIG. 3A but differ primarily in that (i) the first end portion 10 comprises more than one thickness (e.g., two different thicknesses t4, t5) each of which is greater than the thickness t3 of the middle portion 30, and (ii) the second end portion 20 likewise comprises more than one thickness (e.g., two different thicknesses t6, t7) each of which is greater than the thickness t3 of the middle portion 30. In various examples, the thickness t3 of the middle portion 30 may be 3 mm, while the thicknesses t4, t7 and t5, t6 may be 7.5 mm and 6 mm, respectively. It should be appreciated that in various other examples, the thicknesses t4, t7 may be different from one another so long as they are each greater than the thicknesses of t5, t6, respectively, and each greater than the thickness t3 of the middle portion 30. Similarly, it should be appreciated that in various other examples, the thicknesses t5, t6 may be different from one another so long as they are each less than the thicknesses, t4, t7, respectively, and each greater than the thickness t3 of middle portion 30.

More specifically, like in FIG. 3A, in these embodiments illustrated by FIG. 4A, the middle portion 30 comprises first and second longitudinal edges or faces 30b1, 30b2 and extends longitudinally from the first longitudinal edge or face 30b1 to the second longitudinal edge or face 30b2. The first end portion 10 similarly comprises first and second longitudinal edges or faces 10b, 10c and extends longitudinally from the first edge or face 10b to the second edge or face 10c. The first longitudinal edge or face 30b1 of middle portion 30 abuts, faces or is positioned adjacent to the first edge or face 10b of first end portion 10. The second end portion 20 also comprises first and second longitudinal edges or faces 20c, 20b and extends longitudinally from the first edge or face 20c to the second edge or face 20b. The second edge or face 30b2 of the middle portion 30 abuts, faces or is positioned adjacent to the second edge or face 20b of the second end portion 20. It should thus be appreciated that the middle portion 30 in these embodiments may comprise or define a unitary or integral piece (e.g., a single piece) of flexible, light transmissive material 110a (which may be any suitable flexible, light transmissive material described herein). Similarly, the first end portion 10 may comprise or define a unitary or integral piece (e.g., a single piece) of flexible, light transmissive material 110b (which may be any suitable flexible, light transmissive material described herein). Similarly, the second end portion 20 may comprise or define a unitary or integral piece (e.g., a single piece) of flexible light transmissive material 110b (which may be any suitable flexible, light transmissive material described herein). It should also be appreciated that in some embodiments, the flexible light transmissive material 110b of the first end portion 10 may be the same as the flexible light transmissive material 110b of the second end portion 20, while in other embodiments the flexible light transmissive material 110b of the first end portion 10 may be different from the flexible light transmissive material 110b of the second end portion 20.

Like FIGS. 3A and 3B, the embodiments illustrated by FIG. 4A include a substantially flat top surface 10a for first end portion 10 and a substantially flat top surface 20a for second end portion 20. Here, the flat top surface 10a of first end portion 10 comprises two substantially flat top surfaces 10a1, 10a2 corresponding with thicknesses t4, t5, respectively, while the flat top surface 20a of second end portion 20 also comprises two substantially flat top surfaces 20a2, 20a1 corresponding with thicknesses t6, t7. That is, thickness t4 of first end portion 10 extends to top surface 10a1, while thickness t5 of first end portion 10 extends to top surface 10a2. Similarly, thickness t6 of second end portion 20 extends to top surface 20a2, while thickness t7 of second end portion 20 extends to top surface 20a1. It should therefore be appreciated that each top surface 10, 20 (including respective top surfaces 10a1, 10a2 and 20a1, 20a2) may be substantially flat and configured for dice to roll thereupon and to stop (or land). Middle portion 30 in these embodiments similarly includes a top surface 30a, which also may be substantially flat and configured for dice to roll thereupon and to stop (or land).

Turning now more specifically FIG. 4B, these embodiments are similar to FIG. 3B in that rather than the first and second end portions 10, 20 having edges or faces 10b, 20b that abut against or face respective longitudinal edges or faces 30b1, 30b2 of middle portion 30, here a portion of the first end portion 10, a portion of the second end portion 20 and the middle portion 30 together may comprise or define a unitary or integral piece (e.g., a single piece) of flexible, light transmissive material 110a (which may be any suitable flexible, light transmissive material as described herein) and define a bottom layer or bottom integral piece of play field 110. The integral bottom layer piece may extend underneath only a portion of the first and second end portions 10, 20, or extend completely underneath the first and second end portions 10, 20 (e.g., from one longitudinal end of play field 110 to the other longitudinal end of the play field 110). Like in FIG. 3B, in these embodiments, the first end portion 10 comprises a top portion 12 and a bottom portion 14 positioned under the top portion 12 (e.g., positioned directly under or abutting the top portion 12). The second end portion 20 likewise comprises a top portion 22 and a bottom portion 24 positioned under the top portion 22 (e.g., positioned directly under or abutting the top portion 22). The top portions 12, 22 each comprise respective top surfaces 10a, 20a. Here again, like in FIG. 4A, top surface 10a comprises two substantially flat top surfaces 10a1, 10a2 corresponding with thicknesses t4, t5, respectively. Top surface 20a similarly comprises two substantially flat top surfaces 20a2, 20a1 corresponding with thicknesses t6, t7, respectively. That is, the thickness t4 of first end portion 10 extends to top surface 10a1, while thickness t5 of first end portion 10 extends to top surface 10a2. Similarly, thickness t6 of second end portion 20 extends to top surface 20a2, while thickness t7 of second end portion 20 extends to top surface 20a1. Each top surface 10a, 20a (including respective top surfaces 10a1, 10a2 and 20a1, 20a2) may be substantially flat and configured for dice to roll thereupon and to stop (or land). Middle portion 30 in this embodiment similarly includes a top surface 30a, which also may be substantially flat and configured for dice to roll thereupon and to stop (or land).

Like the primary difference between FIG. 4A and FIG. 3A, FIG. 4B differs primarily from FIG. 3B in that (i) the first end portion 10 comprises multiple different thicknesses (e.g., two different thicknesses t4, t5), each of which is greater than the thickness t3 of the middle portion 30, and (ii) the second end portion 20 likewise comprises multiple thicknesses (e.g., two different thicknesses t6, t7), each of which is greater than the thickness t3 of the middle portion 30. In various examples, the thickness t3 of middle portion 30 may be 3 mm, while the thicknesses t5, t6 may each be 6 mm and the thicknesses t4, t7 may each be 7 mm. It should be appreciated that in various other examples, the thicknesses t4, t7 may be different from one another so long as they are each greater than the thicknesses t5 and t6, respectively, and each greater than the thickness t3 of middle portion 30. Similarly, it should be appreciated that in various other examples, the thicknesses t5, t6 may be different from one another so long as they are each less than the thicknesses t4 and t7, respectively, and each greater than the thickness t3 of middle portion 30. It should therefore be appreciated that in the embodiments illustrated by FIGS. 4A, 4B, (and FIGS. 5A, 5B discussed below) each end portion 10, 20 may define or comprise multiple steps or stepped portions (e.g., two steps or stepped portions), each step of which has a thickness greater than the middle portion 30 and which thicknesses increase in the longitudinal direction 170 going away from throw line 190 and towards each longitudinal end of the play field 110. In various other examples, each end portion 10, 20 may define or comprise more than two steps or stepped portions.

Referring now to FIG. 5A and FIG. 5B, these embodiments are similar to FIG. 4A and FIG. 4B, respectively, (with certain reference numerals from FIGS. 4A, 4B omitted from FIGS. 5A, 5B for clarity or ease of illustration), but differ primarily in that each end portion 10, 20 comprises multiple separate pieces of the flexible, light transmissive material (e.g., each end portion comprises two separate pieces of material). In the examples illustrated, first end portion 10 comprises a first flexible, light transmissive material 110b1 and a second, separate piece of flexible, light transmissive material 110b2, which abuts or is adjacent to the first piece of flexible, light transmissive material 110b1. Similarly, second end portion 20 comprises a first flexible, light transmissive 110b1 and a second, separate piece of flexible, light transmissive material 110b2, which abuts or is adjacent to the first flexible, light transmissive material 110b1. Like the embodiments of FIGS. 4A, 4B, in these embodiments, the first end portion 10 comprises multiple thicknesses (e.g., two different thicknesses t4, t5), each of which is greater than the thickness t3 of the middle portion 30, and the second end portion 20 likewise comprises multiple thicknesses (e.g., two different thicknesses t6, t7), each of which is greater than the thickness t3 of the middle portion 30. In various examples, the thickness t3 of the middle portion 30 may be 3 mm, while the thicknesses t4, t7 may each be 7.5 mm and the thicknesses t5, 67 may each be 6 mm. It should be appreciated that in various other examples, the thicknesses t4, t7 may be different from one another so long as they are each greater than the thicknesses t5, t6, respectively, and each greater than the thickness t3 of the middle portion 30. Similarly, it should be appreciated that in various other examples, the thicknesses t5, t6 may be different from one another so long as they are each less than the thicknesses t4, t7, respectively, and each greater than the thickness t3 of middle portion 30. It should also be appreciated that in various examples, the thicknesses difference between t4, t5 may be any suitable difference so long as thickness t4 is greater than thickness t5, and the thicknesses t4, t5 are each greater than the thicknesses t3 of middle portion 30. Similarly, it is contemplated that the thicknesses difference between t6, t7 may be any suitable difference so long as the thickness t7 is greater than the thickness t6, and the thicknesses t6, t7 are each greater than the thickness t3 of middle portion 30.

In various examples, the first, flexible light transmissive material 110b1 of first end portion 10 may be the same material as the second, flexible light transmissive material 110b2 of first end portion 10, e.g., urethane or any other suitable flexible, light transmissive material described herein. Similarly, the first, flexible light transmissive material 110b1 of second end portion 20 may be the same material as the second, flexible light transmissive material 110b2 of second end portion 20, e.g., urethane or any other suitable flexible, light transmissive material described herein. In other embodiments, it is contemplated that the first, flexible light transmissive material 110b1 of first end portion 10 may be a different material from the second, flexible light transmissive material 110b2 of first end portion 10, and the first, flexible light transmissive material 110b1 of second end portion 20 may be a different material from the second, flexible light transmissive material 110b2 of second end portion 20. It is further contemplated that the first, flexible light transmissive material 110b1 of first end portion 10 may be softer than the second, flexible light transmissive material 110b2, as the proximity of material 110b1 near the end means that any additional bounce of thrown dice caused by such softer material will likely cause the dice to hit the adjacent wall, thereby containing such bounced dice within the casino dice table 100. Similarly, it is further contemplated that the second, flexible light transmissive material 110b2 of second end portion 20 may be softer than the first, flexible light transmissive material 110b1, as the proximity of material 110b2 near the end means that any additional bounce of thrown dice caused by such softer material will likely cause the dice to hit the adjacent wall, thereby containing such bounced dice within the casino dice table 100.

Referring to FIG. 5B, these embodiments are similar to FIG. 4B in that rather than the first and second end portions 10, 20 having edges or faces 10b, 20b (present in FIG. 5A but no reference numerals included for ease of illustration or clarity) that abut against or face respective longitudinal edges or faces 30b1, 30b2 (present in FIG. 5B but no reference numerals included for clarity or ease of illustration) of middle portion 30, here a portion of the first end portion 10, a portion of the second end portion 20 and the middle portion 30 together may comprise or define a unitary or integral piece (e.g., a single piece) of flexible, light transmissive material 110a (which may be any suitable flexible, light transmissive material as described herein) and define a bottom layer or bottom integral piece of play field 110. The integral bottom layer piece may extend underneath only a portion of the first and second end portions 10, 20, or extend completely underneath the first and second end portions 10, 20 (e.g., from one longitudinal end of play field 110 to the other longitudinal end of the play field 110). Like in FIG. 3B and FIG. 4B, in these embodiments, the first end portion 10 comprises a top portion 12 and a bottom portion 14 positioned under the top portion 12 (e.g., positioned directly under or abutting the top portion 12). Here, however, the top portion 12 comprises the first and second separate pieces of flexible, light transmissive materials 110b1, 110b2 of first end portion 10. The second end portion 20 likewise comprises a top portion 22 and a bottom portion 24 positioned under the top portion 22 (e.g., positioned directly under or abutting the top portion 22). Here, however, like top portion 12 of first end portion 10, top portion 22 of second end portion 20 comprises the first and second separate pieces of flexible, light transmissive materials 110b1, 110b2 of second end portion 20. The top portions 12, 22 each comprise respective top surfaces 10a, 20a with top surface 10a comprising two substantially flat top surfaces 10a1, 10a2 corresponding with thicknesses t4 and t5, respectively, and with top surface 20a similarly comprising two substantially flat top surfaces 20a2, 20a1 corresponding with thicknesses t6 and t7, respectively. That is, the thickness t4 of first end portion 10 extends to top surface 10a1, while the thickness t5 of first end portion 10 extends to top surface 10a2. Similarly, thickness t6 of second end portion 20 extends to top surface 20a2, while thickness t7 of second end portion 20 extends to top surface 20a1. Each top surface 10a, 20a (including respective top surfaces 10a1, 10a2 and 20a1, 20a2) may be substantially flat and configured for dice to roll thereupon and to stop (or land). Middle portion 30 in this embodiment similarly includes a top surface 30a, which also may be substantially flat and configured for dice to roll thereupon and to stop (or land).

In the embodiments illustrated by FIGS. 5A, 5B, for each of the first end portion 10 and the second end portion 20, the hardness of the piece of flexible, light transmissive material positioned furthest away from a respective longitudinal end or wall of the table (e.g., positioned at the end of play field 110 that is closer to throw line 190 and closer to the top surface 30a upon which dice may stop and roll of middle portion 30) may be the same or different from the hardness of the separate piece of flexible, light transmissive material positioned closer to the respective longitudinal end or wall of the table. In one example, the hardness of each piece of flexible light transmissive materials 110b1, 110b2 of first 10 and second end portion 20 may be 40 Shore A, while the hardness of the middle portion may be 50 Shore A. It has been discovered that a dice table with a play surface material located at position located too far from a longitudinal end or wall of the table that is too soft may cause dice to bounce off the table when thrown. It has also been discovered that some forms of play surface material, such as urethane, may become noticeably tacky relative to the surface of the dice (e.g., a smooth plastic surface of the dice) when their softness increases. While the play surface may be treated with wax or other surface treatment, to try to reduce stickiness, applying such surface treatment is contemplated to having undesirable characteristics such as reduced light transmissivity through the surface, causing the surface treatment material to accumulate on the dice (thereby compromising the integrity of the dice, and creating increased maintenance costs related to reapplying the surface treatment). Embodiments contemplated herein, including, for example, the embodiments illustrated in FIGS. 5A, 5B, help overcome these problems and other problems. For example, having separate pieces of flexible, light transmissive material at the end portions and a separate material for the middle portion (like those illustrated in FIGS. 5A, 5B for example), each end portion of the play surface can easily comprise different hardness, while the middle portion of the play surface can easily have a hardness different from both end portions. This can provide a table in which the play surface is easily designed or modified to have varying hardness levels along the length of the surface, thereby providing a surface in which dice are less likely to bounce off of when thrown towards an end portion of the surface and/or a less predictable roll of the dice will be created.

In various embodiments of FIGS. 3A-5B a hardness of at least a portion of the middle portion 30 including the top surface 30a may be harder than (i) a hardness of at least a portion of the first end portion 10 including the top surface 10a (including top surfaces 10a1 and 10a2), and (ii) a hardness of at least a portion of the second end portion 20 including the top surface 20a (including top surfaces 20a1, 20a2). For example, in the embodiments of FIG. 3A, 4A, 5A a hardness of the middle portion 30 (e.g., the entire middle portion 30) may be harder than a hardness of at least a portion of first end portion 10 (e.g., the entire first end portion 10 or at least the top surface(s) of first end portion 10). Similarly, a hardness of the middle portion 30 may be harder than a hardness of at least a portion of second end portion 20 (e.g., the entire second end portion 10 or at least the top surface(s) of second end portion 20).

In various embodiments of FIGS. 3B, 4B, 5B, a hardness of the middle portion 30 (e.g., the entire middle portion 30) may be harder than (i) a hardness of at least a portion of top portion 12 of first end portion 10 (e.g., the entire top portion 12 or at least the top surface(s) of top portion 12), and (ii) a hardness of at least a top portion 22 of second end portion 20 (e.g., the entire top portion 22 or at least the top surface(s) of top portion 22). It should therefore be appreciated that in embodiments illustrated by FIGS. 3B, 4B, 5B the hardness of the entire bottom layer piece defined by the bottom portion 14 (of first end portion 10), the middle portion 30 and the bottom portion 24 (of second end portion 20) may be harder than a hardness of at least a portion of top portions 12 and 22 of (of first and second end portions 10 and 20, respectively). It should also be appreciated that in various embodiments of FIGS. 3A-5B, that while the hardness of at least a portion of first end portion 10 and/or second end portion 20 each may be less than a hardness of a portion of middle portion (which may include the entire unitary bottom layer piece in embodiments like FIG. 3B), the hardness of first end portion 10 may not be the same as the hardness of the second end portion 20.

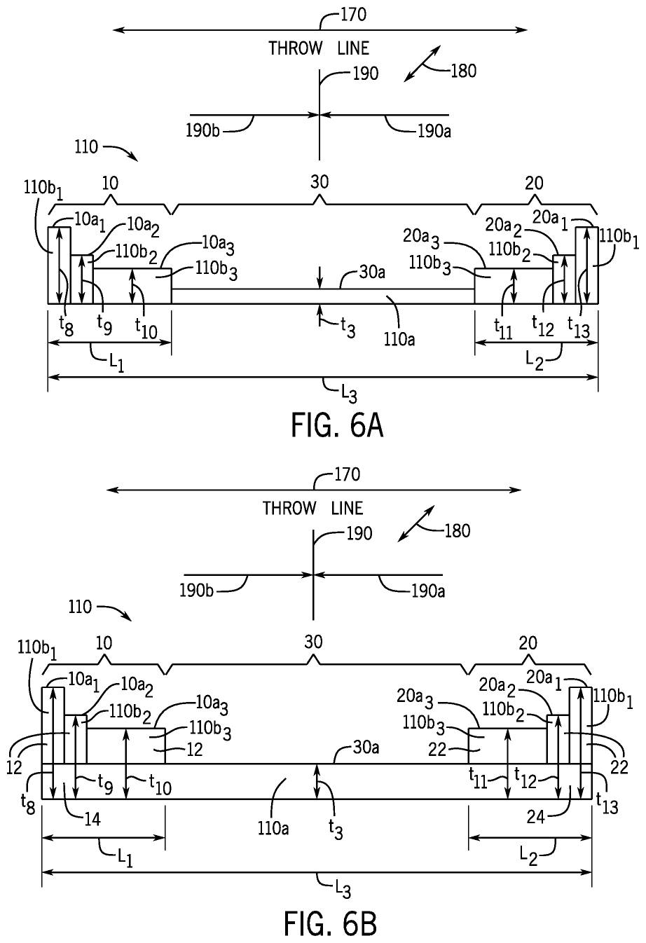

Turning now to the embodiments illustrated by FIGS. 6A, 6B, these embodiments are similar to the embodiments of FIGS. 5A, 5B, respectively, (certain reference numerals from FIGS. 5A, 5B have been omitted from FIGS. 6A, 6B for clarity or ease of illustration), but differ primarily in that each end portion 10, 20 comprises three separate pieces of the flexible, light transmissive material rather than two separate pieces of flexible, light transmissive material like in FIGS. 5A and 5B. In particular, in the embodiments illustrated by FIG. 6A, first end portion 10 comprises a first flexible, light transmissive material 110b1, a second, separate piece of flexible, light transmissive material 110b2, which abuts or is adjacent to the first piece of flexible, light transmissive material 110b1, and a third, separate piece of flexible, light transmissive material 110b3, which abuts or is adjacent to the second, flexible light transmissive material 110b2. Similarly, second end portion 20 comprises a first flexible, light transmissive 110b1, a second, separate piece of flexible, light transmissive material 110b2, which abuts or is adjacent to the first flexible, light transmissive material 110b1, and a third, separate piece of flexible, light transmissive material 110b3, which abuts or is adjacent to the second, flexible light transmissive material 110b2. Like the embodiments of FIGS. 4A-5B, in these embodiments, the first end portion 10 comprises multiple thicknesses (in this example three different thicknesses t8, t9, t10), each of which is greater than the thickness t3 of the middle portion 30. The second end portion 20 likewise comprises multiple thicknesses (in this example three different thicknesses t11, t12, t13), each of which is greater than the thickness t3 of the middle portion 30.

In various examples, the thickness t3 of the middle portion 30 may be 3 mm, the thicknesses t8, t13 may each be 7.5 mm, the thicknesses t9, t12 may each be 6 mm, and the thicknesses t10, t11 may each be 4.5 mm. It should be appreciated that in various other examples, the thicknesses t8, t13 may be different from one another so long as they are each greater than: the thicknesses t9, t12, respectively, the thickness t10, t11, respectively, and the thickness t3 of the middle portion 30 such that the thicknesses create steps or stepped portions that increase incrementally in a direction away from the throw line 190 towards longitudinal end of play field 110. Similarly, it should be appreciated that in various other examples, the thicknesses t9, t12 may be different from one another so long as they are each less than the thicknesses t8, t13, respectively, and each greater than the thickness t10, t11, respectively and t3 of middle portion 30 such that the thicknesses create steps or stepped portions that increase incrementally in a direction away from the throw line 190 towards longitudinal end of play field 110. Likewise, it should be appreciated that in various other examples, the thicknesses t10, t11 may be different from one another so long as they are each less than the thicknesses t9, t12, respectively, and t8, t13, respectively, and each greater than the thickness t3 of middle portion 30 such that the thicknesses create steps or stepped portions that increase incrementally in a direction away from the throw line 190 towards each longitudinal end of play field 110. It should also be appreciated that in various examples, the thicknesses difference between t8, t9 and t9, t10 may be any suitable difference so long as thickness t8 is greater than thickness t9, and the thicknesses t9 is greater than the thickness t10 and the thicknesses t8, t9, t10 are each greater than the thicknesses t3 of the middle portion 30 such that the thicknesses create steps or stepped portions that increase incrementally in a direction away from the throw line 190 towards each longitudinal end of play field 110. Similarly, it is contemplated that the thicknesses difference between t13, t12 and t12, t11 may be any suitable difference so long as the thickness t13 is greater than the thickness t12, and the thickness t12 is greater than the thickness t11 and the thicknesses t13, t12, t11 are each greater than the thickness t3 of the middle portion 30.

In examples of FIG. 6A, the first, second and third flexible light transmissive materials 110b1, 110b2, 110b3 of first end portion 10 may be the same materials, e.g., urethane or any other suitable flexible, light transmissive material described herein. Similarly, the first, second and third flexible light transmissive materials 110b1, 110b2, 110b3 of second end portion 20 may be the same material, e.g., urethane or any other suitable flexible, light transmissive material described herein. In other embodiments, it is contemplated that the first, second and third flexible light transmissive materials 110b1, 110b2, 110b3 of first end portion 10 may be different materials and the first, second and third flexible light transmissive materials 110b1, 110b2, 110b3 of second end portion 20 may be different materials. It is further contemplated that the first, second and third flexible light transmissive materials 110b1, 110b2, 110b3 of both the first end portion 10 and second end portion 20 may be the same as the flexible, light transmissive material 110a of the middle portion 30. In various other examples, the first, second and third flexible light transmissive materials 110b1, 110b2, 110b3 of the first end portion 10 may be different from the flexible, light transmissive material 110a of the middle portion 30. Likewise, the first, second and third flexible light transmissive materials 110b1, 110b2, 110b3 of the second end portion 10 may be different from the flexible, light transmissive material 110a of the middle portion 30.

In yet further examples of FIG. 6A, it is contemplated that a hardness of (i) the first end portion 10 (e.g., a hardness of each of the first, second and third flexible light transmissive materials 110b1, 110b2, 110b3 of first end portion 10) may be the same or substantially the same as a hardness of the second end portion 20 (e.g., a hardness of each of the first, second, and third flexible light transmissive materials 110b1, 110b2, 110b3 of second end portion 20), and (ii) the same or substantially the same as a hardness of the middle portion 30 (e.g., a hardness of each of the first, second and third flexible light transmissive materials 110b1, 110b2, 110b3 of second end portion 20). In one example, the hardness of each of the first end portion 10 (e.g., a hardness of each of the first, second, and third flexible light transmissive materials 110b1, 110b2, 110b3 of first end portion 10), the second end portion 20 (e.g., a hardness of each of the first, second, and third flexible light transmissive materials 110b1, 110b2, 110b3 of second end portion 20) and middle portion 30 may be 50 Shore A. In examples, each of the first, second and middle portions 10, 20, 30 may comprise any suitable hardness discussed herein and suitable for dice throwing is contemplated, e.g., 40 Shore A or 30 Shore A.

Still referring to FIG. 6A, it is further contemplated that the first, flexible light transmissive material 110b1 of first end portion 10 may be softer than the second, flexible light transmissive material 110b2 of first end portion 10, and second flexible light transmissive material 110b2 of first end portion 10 may be softer than third flexible light transmissive material 110b3 of first end portion 10 as the proximity of material near the end means that any additional bounce of thrown dice caused by such softer material will likely cause the dice to hit the adjacent wall, thereby containing such bounced dice within the casino dice table 100. Similarly, it is further contemplated the first, flexible light transmissive material 110b1 of second end portion 20 may be softer than the second, flexible light transmissive material 110b2 of second end portion 20, and second flexible light transmissive material 110b2 of second end portion 20 may be softer than third flexible light transmissive material 110b3 of second end portion 20 as the proximity of material near the end means that any additional bounce of thrown dice caused by such softer material will likely cause the dice to hit the adjacent wall, thereby containing such bounced dice within the casino dice table 100. In various other examples, for one or both of the first and second end portions 10, 20, the second flexible light transmissive material 110a may be softer than the respective the second flexible light transmissive material 110b, while the respective third flexible light transmissive material 110b1 may be the same hardness as the second light transmissive material 110b1.

Referring now to FIG. 6B, these embodiments are similar to FIG. 5B in that rather than the first and second end portions 10, 20 having edges or faces 10b, 20b (present in FIG. 6B but no reference numerals included for clarity or ease of illustration) that abut against or face respective longitudinal edges or faces 30b1, 30b2 (present in FIG. 6B but no reference numerals included for clarity or ease of illustration) of middle portion 30, here a portion of the first end portion 10, a portion of the second end portion 20 and the middle portion 30 together may comprise or define a unitary or integral piece (e.g., a single piece) of flexible, light transmissive material 110a (which may be any suitable flexible, light transmissive material as described herein) and define a bottom layer or bottom integral piece of play field 110. The integral bottom layer piece may extend underneath only a portion of the first and second end portions 10, 20, or extend completely underneath the first and second end portions 10, 20 (e.g., from one longitudinal end of play field 110 to the other longitudinal end of the play field 110). Like in FIG. 3B, FIG. 4B, and FIG. 5B, in these embodiments, the first end portion 10 comprises a top portion 12 and a bottom portion 14 positioned under the top portion 12 (e.g., positioned directly under or abutting the top portion 12). Here, however, the top portion 12 comprises the first, second and third separate pieces of flexible, light transmissive materials 110b1, 110b2, 110b3 of first end portion 10. The second end portion 20 likewise comprises a top portion 22 and a bottom portion 24 positioned under the top portion 22 (e.g., positioned directly under or abutting the top portion 22). Here, however, like top portion 12 of first end portion 10, top portion 22 of second end portion 20 comprises the first, second and third separate pieces of flexible, light transmissive materials 110b1, 110b2, 110b3 of second end portion 20. The top portions 12, 22 each comprise respective top surfaces 10a, 20a with top surface 10a comprising three substantially flat top surfaces 10a1, 10a2, 10a3 corresponding with thicknesses t8, t9, t10, respectively, and with top surface 20a similarly comprising three substantially flat top surfaces 20a1, 20a2, 20a3 corresponding with thicknesses t13, t12, t11, respectively. That is, the thickness t8 of first end portion 10 extends to top surface 10a1, the thickness t9 of first end portion 10 extends to top surface 10a2, and the thickness t10 extends to top surface 10a3. Similarly, thickness t13 of second end portion 20 extends to top surface 20a1, the thickness t12 of second end portion 20 extends to top surface 20a2, and the thickness t11 of second end portion 20 extends to top 20a1. Each top surface 10a, 20a (including respective top surfaces 10a1, 10a2, 10a3 and 20a1, 20a2, 20a3) may be substantially flat and configured for dice to roll thereupon and to stop (or land). Middle portion 30 in this embodiment similarly includes a top surface 30a, which also may be substantially flat and configured for dice to roll thereupon and to stop (or land).

Similar to FIG. 6A, in examples of FIG. 6B, it is contemplated that a hardness of at least a portion of (i) first end portion 10 (e.g., a hardness of each of the first, second and third flexible light transmissive materials 110b1, 110b2, 110b3 of first end portion 10) may be the same or substantially the same as a hardness of at least a portion of second end portion 20 (e.g., a hardness of each of the first, second, and third flexible light transmissive materials 110b1, 110b2, 110b3 of second end portion 20), and (ii) the same or substantially the same as a hardness of the middle portion 30 (e.g., a hardness of each of the first, second and third flexible light transmissive materials 110b1, 110b2, 110b3 of second end portion 20). In one example, the hardness of at least a portion of the first end portion 10 (e.g., a hardness of each of the first, second, and third flexible light transmissive materials 110b1, 110b2, 110b3 of first end portion 10), at least a portion of the second end portion 20 (e.g., a hardness of each of the first, second, and third flexible light transmissive materials 110b1, 110b2, 110b3 of second end portion 20) and the middle portion 30 may each be 50 Shore A. In examples, at least a portion of the hardness each of the first, second and middle portions 10, 20, 30 may comprise any suitable hardness discussed herein and suitable for dice throwing is contemplated, e.g., 40 Shore A or 30 Shore A.

In various examples herein including any of the embodiments illustrated, the hardness of at least a portion of the middle portion 30 may be approximately 50 Shore A (e.g., the hardness of flexible, light transmissive material 110a), while the hardness of at least a portion of the first and second end portions 10, 20 may be approximately 40 Shore A or 30 Shore A (e.g., the hardness of flexible, light transmissive material 110b or the hardness of each of material pieces 110b1, 110b2). In other examples, the hardness of at least a portion of the middle portion 30 may be in the range of approximately 30 to 70 Shore A (e.g., the hardness of flexible, light transmissive material 110a), while the hardness of a least a portion of the first and second end portions 10, 20 may be in the range of approximately 10 to 50 Shore A (e.g., the hardness for at least a portion of the flexible, light transmissive material 110b or each of material pieces 110b1, 110b2). In such embodiments, the difference in hardness may correlate with a change in friction exerted onto sliding dice by the play field, which would promote tumbling of the dice. For example, a thrown dice encountering a softer material would experience more friction, and therefore be induced to further tumble. Other hardness levels for the respective portions or integral or unitary flexible light transmissive material pieces herein are contemplated (including the bottom layer piece illustrated in FIGS. 3B, 4B, 5B and 6B are contemplated herein), with the primary consideration being that the respective hardness should be designed to provide adequate softness to absorb the dice being thrown.

It should be appreciated from the foregoing that in examples herein, including the illustrated embodiments discussed herein, the first end portion 10 may comprise both (i) a thickness (e.g., a single thickness or multiple thicknesses such as two thicknesses, three thickness, or more than three thicknesses) that is greater than a thickness of the middle portion 30 and (ii) at least a portion with a hardness that is different from (e.g., less than) the middle portion 30. Likewise, the second end portion 20 may comprise both (i) a thickness (e.g., a single thickness or multiple thicknesses such as two thicknesses, three thicknesses or more than three thicknesses) that is greater than a thickness of the middle portion 30 and (ii) at least a portion with a hardness that is different from (e.g., less than) the middle portion 30.

It should also be appreciated from the foregoing that in examples herein, including the illustrated embodiments described herein, the hardness of the middle portion 30 may be the same or substantially the same as the hardness of one or both of the first and second end portions 10, 20 (including each step or stepped portion defined by the end portion). In further embodiments, it is contemplated that the middle portion 30 may have the same thickness as one or both of the first and second end portions 10, 20, but with a greater hardness than one or more of the first and second end portions 10, 20.

In still further embodiments, an additional material may cover play field 110, such as a netting or similar textile material. In such embodiments, it is contemplated that such further covering material would still be required to allow the displayed images to show through such material, and therefore would be thin enough that it would not significantly interfere with the desired effects that the contemplated play field material arrangements contemplated herein would have on thrown dice.

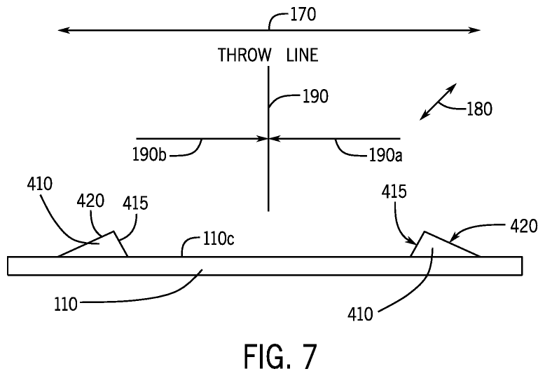

FIG. 7 illustrates additional embodiments of the present disclosure in which bumpers 410 are added to the play field 110. In these embodiments, bumpers 410 have a dice roll surface or side 415, which may be steeper than a dice retrieval surface or side 420 (e.g., steeper relative to a horizontal top surface 110c of play field 110). As illustrated in FIG. 7, the steeper dice roll side or surface 415 may be positioned to face the center of the play field 110 so as to face oncoming dice being thrown by a player, as illustrated by throw line 190. The shallower dice retrieval surface or side 420 is positioned to face an edge of play field 110. In these embodiments, the steeper slope of the dice roll side or surface 415 will cause any dice sliding over it to tumble, while the shallower slope of the dice retrieval surface or side 420 would allow a dealer to retrieve dice that come to rest near the edge of the play field 110 by dragging the dice back over the bumper 410 without the bumper causing the dice to change the displayed result. The bumpers 410 could therefore be deployed across an entire width of the play field 110. In embodiments, the height of the bumper may be between 2 mm and 10 mm. In other embodiments, the height of the bumper may be between 4 mm and 7 mm. In various embodiments, the slope of the dice roll surface or side 415 should be at least twice the slope of the dice retrieval surface 420. In another embodiment, the slope of the dice roll surface or side 415 may be vertical.

While FIGS. 3A-7 illustrate embodiments where the casino dice table resembles a traditional craps table (i.e., dice can be thrown by a player in either direction, depending on where the player is located), it should be appreciated that the present disclosure is applicable to other casino dice tables that only allow dice to be thrown in a single direction. For example, such a table could require players to throw dice from only a single end towards the other end. In such embodiments, only the first portion 10 or the second end portion 20 may comprise a different thickness from the middle portion 30, e.g., only one end portion of the craps table may have a step or stepped portion and/or a different material hardness from the rest of the table.

Further examples are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the present disclosure.

What is claimed is:

1. A casino dice table comprising:
a play field positioned substantially horizontally, the play field comprising:
a first end portion comprising:
a flexible, light transmissive material,
a substantially flat top surface upon which physical dice may roll and stop, and
a thickness,
a second end portion opposite the first end portion, the second end portion comprising:
a flexible, light transmissive material,
a substantially flat top surface upon which physical dice may roll and stop, and
a thickness, and
a middle portion disposed between the first end portion and the second end portion, the middle portion comprising:
a flexible, light transmissive material,
a substantially flat top surface upon which physical dice may roll and stop, and
a thickness, and
wherein: (i) the thickness of the first end portion is greater than the thickness of the middle portion, and (ii) the thickness of the second end portion is greater than the thickness of the middle portion, and
at least one electronic display device positioned under the play field, the at least one electronic display device configured and arranged so that images displayed by the at least one electronic display device are viewable on, or through, the play field.

2. The casino dice table of claim 1, wherein:
(i) the thickness of the first end portion comprises a first thickness and a second different thickness, the first and second thicknesses of the first end portion each greater than the thickness of the middle portion, and
(ii) the thickness of the second end portion comprises a first thickness and a second different thickness, the first and second thicknesses of the second end portion each greater than the thickness of the middle portion.

3. The casino dice table of claim 2, wherein:
(i) the flexible, light transmissive material of the first end portion comprises a first piece of flexible, light transmissive material and a second separate piece of flexible, light transmissive material, the first piece of flexible, light transmissive material of the first end portion comprising the first thickness of the first end portion, the second flexible, light transmissive material of the first end portion comprising the second thickness of the first end portion,
(ii) the flexible, light transmissive material of the second end portion comprises a first piece of flexible, light transmissive material and a second separate piece of flexible, light transmissive material, the first piece of flexible, light transmissive material of the first end portion comprising the first thickness of the first end portion, the second flexible light transmissive material of the first end portion comprising the second thickness of the first end portion,
(iii) the thickness of the first flexible, light transmissive material of the first end portion greater than the thickness of the second separate flexible, light transmissive material of first end portion, and
(iv) the thickness of the first flexible, light transmissive material of the second end portion greater than the thickness of the second separate flexible, light transmissive material of the second end portion.

4. The casino dice table of claim 3, wherein:
(i) a hardness of the second flexible light transmissive material of the first end portion is the same as a hardness of the first flexible light transmissive material of the first end portion, and
(ii) a hardness of the second flexible light transmissive material of the first end portion is the same as the hardness of the first flexible light transmissive material of the first end portion.

5. The casino dice table of claim 2, wherein:
(i) the substantially flat top surface of the first end portion comprises:
a first substantially flat top surface upon which dice may roll and stop, the first thickness of the first end portion extending to the first substantially flat top surface of the first end portion, and
a second substantially flat top surface upon which dice may roll and stop, the second thickness of the first end portion extending to the second substantially flat top surface of the first end portion, and
(ii) the substantially flat top surface of the second end portion comprises:
a first substantially flat top surface upon which dice may roll and stop, the first thickness of the second end portion extending to the first substantially flat top surface of the second end portion, and
a second substantially flat top surface upon which dice may roll and stop, the second thickness of the second end portion extending to the second substantially flat top surface of the second end portion.

6. The casino dice table of claim 2, wherein:
(i) the first thickness of the first end portion is substantially uniform from a first lateral edge of the play surface to an opposite lateral edge of the play surface,
(ii) the second thickness of the first end portion is substantially uniform from a first lateral edge of the play surface to an opposite lateral edge of the play surface,
(iii) the first thickness of the second end portion is substantially uniform from a first lateral edge of the play surface to an opposite lateral edge of the play surface, and
(iv) the second thickness of the second end portion is substantially uniform from a first lateral edge of the play surface to an opposite lateral edge of the play surface.

7. The casino dice table of claim 1, wherein:
(i) the middle portion comprises:
a bottom surface opposite the substantially flat top surface of the middle portion,
a first end face, and
a second end face opposite the first end face,
(ii) the first end portion comprises:
a bottom surface opposite the substantially flat top surface of the first end portion, and
an end face,
(iii) the second end portion comprises:
a bottom surface opposite the substantially flat top surface of the second end portion, and
an end face,
(iv) the first end face of the middle portion abuts the end face of the first end portion, and
(v) the second end face of the middle portion abuts the end face of the second end portion.

8. The casino dice table of claim 7, wherein:
the middle portion comprises an integral piece of the flexible, light transmissive material of the middle portion, the integral piece extending longitudinally from the first end face of the middle portion to the second end face of the middle portion,
the first end portion comprises an integral piece of the flexible, light transmissive material of the first end portion, and
the second end portion comprises an integral piece of the flexible, light transmissive material of the second end portion.

9. The casino dice table of claim 1, wherein:
(i) the first end portion comprises a bottom portion and a top portion,
(ii) the second end portion comprises a bottom portion and a top portion,
(iii) the middle portion, the bottom portion of the first end portion and the bottom portion of the second end portion define an integral bottom layer piece comprised of a same flexible light transmissive material, and
(iv) a hardness of at least a portion of the integral bottom layer piece including the substantially top flat surface of the middle portion is greater than a hardness of (a) the top portion of the first end portion and (b) the top portion of the second end portion.

10. The casino dice table of claim 9, wherein:
(i) the play field comprises a length, and
(ii) the integral bottom layer piece of the play field extends the length of the play field.

11. The casino dice table of claim 1, wherein:
(i) the first end portion comprises a length,
(ii) the second end portion comprises a length,
(iii) the play field comprises a length,
(iv) the length of the first end portion is between 20% and 35% of the length of the play field, and
(v) the length of the second end portion is between 20% and 35% of the length of the play field.

12. The casino dice table of claim 1, wherein the first end portion and the second end portion extend from one lateral edge of the play surface to another other lateral edge of the play surface.

13. The casino dice table of claim 1, wherein:
(i) the first end portion is located at a first longitudinal end portion of the casino dice table, and
(ii) the second end portion is located at a second longitudinal end portion of the casino dice table.

14. The casino dice table of claim 1, wherein:
(i) a hardness of said at least a portion of the middle portion is in the range of approximately 30 to 70 Shore A, and
(ii) a hardness of said at least a portion of the first and second end portions is in the range of approximately 10 to 50 Shore A.

15. The casino dice table of claim 1, wherein the thickness of the first end portion is substantially equal to the thickness of the second end portion.

16. The casino dice table of claim 1, wherein:
(i) the thickness of the first end portion is at least 3 mm greater than the thickness of the middle portion, and
(ii) the thickness of the second end portion is at least 3 mm greater than the thickness of the middle portion.

17. The casino dice table of claim 1, wherein:
(i) the thickness of the first end portion is between 2 mm and 7 mm greater than the thickness of the middle portion, and
(ii) the thickness of the second end portion is between 2 mm and 7 mm greater than the thickness of the middle portion.

18. The casino dice table of claim 1, wherein:
(i) the thickness of the first end portion is substantially uniform from a first lateral edge of the surface to an opposite lateral edge of the play surface, and
(ii) the thickness of the second end portion is substantially uniform from a first lateral edge of the play surface to an opposite lateral edge of the play surface.

19. The casino dice table of claim 1, wherein the flexible light transmissive material of the middle portion comprises an elastomer or a plastic.

20. The casino dice table of claim 1, wherein the flexible, light transmissive material of the first end portion is the same as the flexible, light transmissive material of the second end portion and the flexible, light transmissive material of the middle portion.

21. The casino dice table of claim 1, wherein a hardness of at least a portion of the middle portion including the substantially flat top surface of the middle portion is the same as (a) a hardness of the first end portion, and (b) a hardness of the second end portion.

22. The casino dice table of claim 1, wherein:
(i) the thickness of the first end portion comprises:
a first thickness,
a second thickness greater than the first thickness of the first end portion,
a third thickness greater than the second thickness of the first end portion, the first, second and third thicknesses of the first end portion each greater than the thickness of the middle portion, and
(ii) the thickness of the second end portion comprises:
a first thickness,
a second thickness greater than the first thickness of the second end portion, and
a third thickness greater than the second thickness of the second end portion, the first, second and third thicknesses of the second end portion each greater than the thickness of the middle portion.

23. The casino dice table of claim 22, wherein:
(i) the flexible, light transmissive material of the first end portion comprises:
a first piece of flexible, light transmissive material,
a second piece of flexible, light transmissive material,
a third piece of flexible, light transmissive material, the first, second and third pieces of flexible, light transmissive material of the first end portion comprise the first, second, and third thicknesses of the first end portion, respectively, and
(ii) the flexible, light transmissive material of the second end portion comprises:
a first piece of flexible, light transmissive material,
a second piece of flexible, light transmissive material, and
a third piece of flexible, light transmissive material, the first, second and third pieces of flexible, light transmissive material of the second end portion comprise the first, second, and third thicknesses of the second end portion, respectively.

24. The casino dice table of claim 1, wherein a hardness of the flexible, light transmissive material of the middle portion is the same as (a) a hardness of each of the first, second and third flexible, light transmissive materials of the first end portion, and (b) a hardness of each of the first, second and third flexible, light transmissive materials of the second end portion.

25. The casino dice table of claim 1, wherein a hardness of at least a portion of the middle portion including the substantially flat top surface of the middle portion is greater than (a) a hardness of at least a portion of the first end portion, and (b) a hardness of at least a portion of the second end portion.
